(19) United States
(12) Patent Application Publication
(10) Pub. No.: US 2005/0132489 A1
(43) Pub. Date: Jun. 23, 2005

(54) Apparatus for dry water jet massaging

(76) Inventor: Hermann B. Henrichs, Wiehl (DE)

Correspondence Address: Klaus J. Bach, 4407 Twin Oaks Drive, Murrysville, PA, 15668, US

(21) Appl. No.: 11/009,741

(22) Filed: Dec. 13, 2004

(30) Foreign Application Priority Data
Dec. 19, 2003 (DE) 203 19 734.8

(51) Int. Cl. A61H 33/04

(52) U.S. Cl. 4/541.6

(57) ABSTRACT

In an apparatus for dry water jet massaging comprising a tub covered by a foil so as to form a support surface onto which water jets are directed from below for massaging a person resting on the foil, a carriage is movably disposed in the tub and crank elements are supported on the carriage and carry water nozzle heads which are independently rotatably supported on the crank elements and supplied with pressurized water by hoses connected to the nozzle heads.

### BACKGROUND OF THE INVENTION

The invention relates to an apparatus for dry water jet massaging, that is, for massaging a body with water jets which however do not come into direct contact with the skin of a patient. Such a “dry” water jet massage is advantageous since it has almost the same effect as an underwater massage with water jets of a patient's body immersed into a water bath but subjects the patient to less stress.

During an underwater massage, the hydrostatic pressure of the water is effective on the body vessels of a patient which, in persons with increased blood pressure or persons tending to high blood pressure, may cause a blood pressure increase during massaging. Furthermore, after the massage treatment, when stepping out of the water bath, the patient may experience a substantial blood pressure drop and a tendency to collapse. Since this occurs very frequently as a result of the classic underwater massages, a patient needs to rest after a massage therapy for almost half an hour. This is not necessary with the dry massage. In addition, the water jet does not excessively stress the skin of the patient as it happens frequently with the wet underwater massage. Also, the annoying after-treatment perspiration with the danger of getting a cold is not present with dry water jet massaging.

An apparatus for dry water jet massaging is already known. It is a full body massaging apparatus with a tub which receives the massaging jet mechanism and is closed at its top by a tensioned foil on which the patient rests. The massaging water jets are directed toward the bottom side of the foil and, in this way, indirectly onto the patient disposed thereon with pressure and temperature effects on the patient. The massaging water jet mechanism comprises a carriage which is longitudinally movable in the tub and is provided with two nozzles which are each supported on pivot arms which are pivoted back and forth by a crank mechanism via a guide structure in a sickle-shaped pattern.

The known massaging apparatus is used only in professional environments that is, in hospitals, rehabilitation centers, massaging establishments or in commercial fitness centers or spas. However, in these known apparatus, the mechanism for generating the jets is not satisfactory particularly, because the supply hoses extending to the nozzles are constantly subjected to alternating bending.

It is the object of the present invention to provide an apparatus for dry water jet massaging which has an improved massaging jet actuating mechanism and is suitable also for use in non-commercial areas.

### SUMMARY OF THE INVENTION

In an apparatus for dry water jet massaging comprising a tub covered by a foil so as to form a support surface onto which water jets are directed from below for massaging a person resting on the foil, a carriage is movably disposed in the tub and crank elements are supported on the carriage and carry water nozzles head which are independently rotatably supported on the crank elements and supplied with pressurized water by hoses connected to the nozzle heads.

The apparatus according to the invention may be designed as a compact apparatus for a partial body treatment but also for full body treatment. It is relatively inexpensive to manufacture and includes a rugged mechanism. It may be in the form of a stationary apparatus or it may be mobile.

The invention will described below on the basis of the accompanying schematic drawings.

### BRIEF DESCRIPTION OF THE DRAWINGS

FIG. 1 is a top view of the apparatus according to the invention, and

FIG. 2 is a cross-sectional view of the apparatus taken along line II-II of FIG. 1.

### DESCRIPTION OF A PREFERRED EMBODIMENT

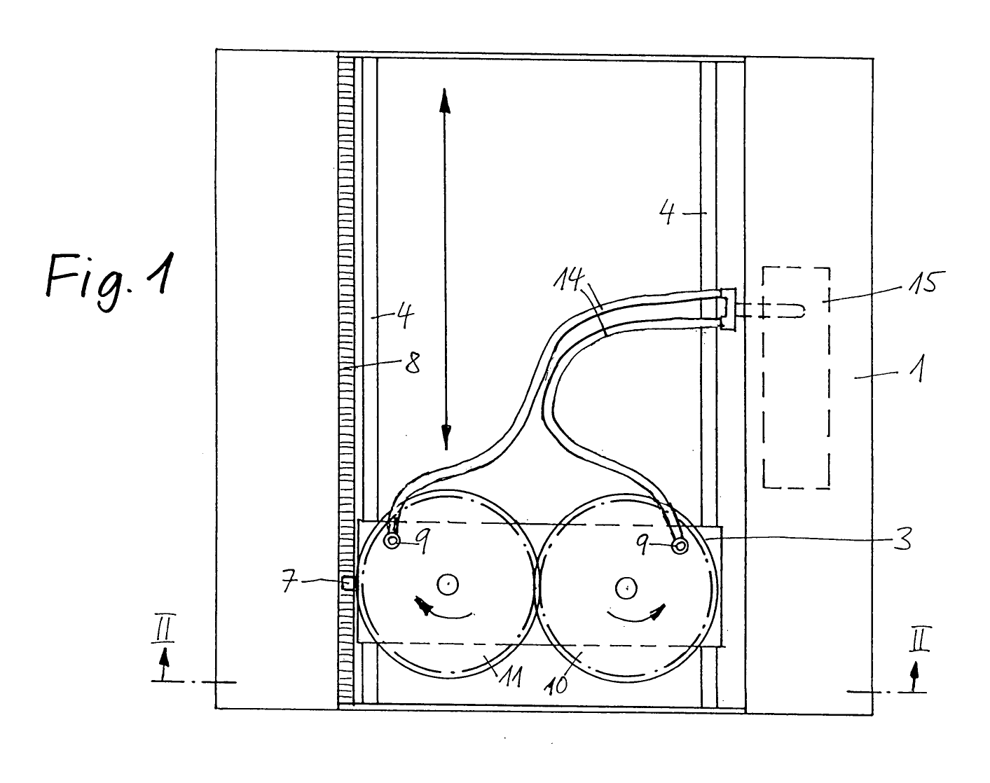

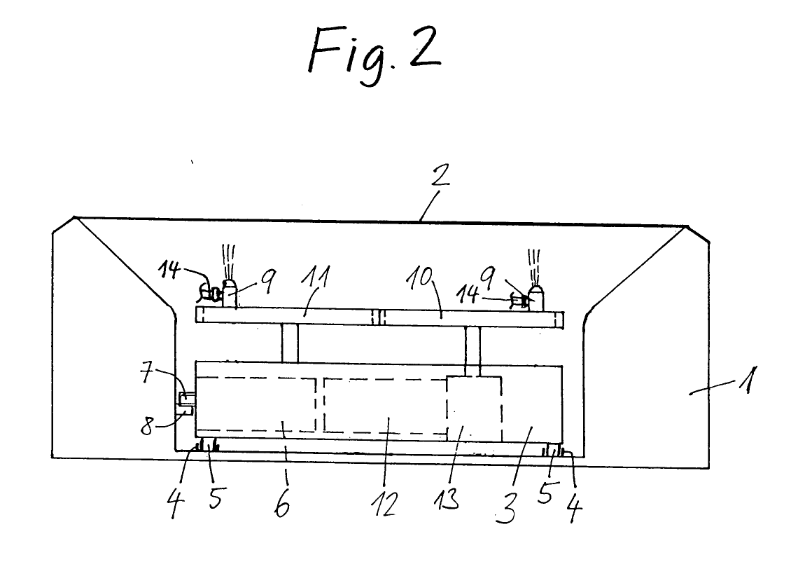

As shown in the figures, the apparatus comprises a tub 1 which is covered by a tensioned foil 2. In the top view of FIG. 1, the foil is omitted. It is shown only in the sectional view of FIG. 2. The patient is resting on the foil 2. If, as shown, the apparatus is a compact apparatus for partial body massaging its length corresponds only to part of the body length of a patient. The apparatus is then provided with an additional support area (not shown) which supplements the support area provided by the foil so that the patient can relaxingly lay on a full body length support surface.

In the tub 1, a carriage 3 is arranged which extends in the transverse direction of the tub and is movable longitudinally back and forth in the tub. To this end, the tub may be provided with tracks 4, on which the carriage is movably supported by rollers 5. Of course, there are other possibilities for movably supporting the carriage 3. The carriage 3 is provided with a drive motor 6, which, by way of a reduction gear structure, drives a pinion 7, which is in engagement with a toothed rod 8 extending along the tub 1 for moving the carriage 3. Of course, also other drive arrangements for moving the carriage may be provided. For example, a spindle with a nut may be provided or a toothed belt or chain drive may be used for driving the carriage 3 longitudinally in the tub 1. A toothed belt drive could be realized for example in such a way that a pinion supported on the carriage engages a toothed belt which extends, tightly tensioned along the wall of the tub wherein a roller mechanism provides for a certain looping angle in the engagement area of the pinion with the toothed belt. A toothed belt or a chain drive however may also be so provided that the drive motor is arranged at the side of the wall of the tub 1 and the toothed belt or the chain or another pull member which is operated by the drive motor moves the carriage 3. In any case, the drive is such that, at its end positions, the movement of the carriage 3 is automatically reversed so that a continuous slow back and forth movement is obtained.

The carriage 3 carries two nozzle heads 9, which each direct a water jet onto the bottom side of the foil 2. Each nozzle head 9 is supported on a crank 10 or, respectively, 11, those cranks being represented in the shown embodiment each by a gear and the two gears are in engagement with each other. In the shown schematic arrangement the gears or cranks 10, 11 are in the form of discs but they may also be annular bodies provided with spokes and another gear ring in order for the arrangement to be lightweight. Instead of gears simple cranks may be used which have shafts which are coupled by drive means. In the embodiment shown, the gear 10 is operated by a drive motor 12 via a transmission 13 and the other gear 11 is driven by its engagement with gear 10.

The respective nozzle head 9 is not firmly mounted on the respective gear or crank (10, 11), but is rotatably supported thereon so that the nozzle head 9 can freely rotate on the gear or crank 10, 11.

Hoses 14, which are connected to the respective nozzle heads 9 extend to a pump 15 which, preferably, is arranged at one side of the tub and which sucks in water from the bottom of the tub and supplies it through the hoses 14 to the nozzle heads 9 under a predetermined pressure. The hoses 14 are flexible and may be supported on a hose carriage by a support structure, which is not shown for clarity, in such a way that there is no interference or collision with the gears and the cranks 10, 11 during operation of the apparatus.

It would also be possible to mount the pump on the carriage 3. This has the advantage that only short hoses would be required but, on the other hand, the weight of the carriage would be increased and a correspondingly stronger drive would be required. With the provision of a strong, rugged carriage drive, it may be advantageous to provide the pump directly on the carriage. If a lightweight construction is desired the arrangement of the pump on the tub would be more suitable.

The gears or, respectively, cranks 10, 11 can rotate continuously so that the nozzle heads 9 are moved along a corresponding orbit path and the respective massaging jet follows a circular path while moving longitudinally in the tub 1. Because of the gear engagement of the cranks or gears 10, 11 the cranks or gears 10, 11 as shown in the FIG. 1, rotate in an opposite sense. Since the nozzle heads are rotatably supported on the cranks or gears 10, 11, the nozzle heads 9 do not rotate on, but orbit only with, the cranks or gears 10, 11.

The drive for the gears or cranks 10, 11 however, may also be such that the gears or cranks 10, 11 do not continuously rotate but rather pivot back and forth by a rotational angle of for example 180° or somewhat less. In this case, they pivot again in an opposite sense so that the massaging jets on the two gears or cranks 10, 11 follow a sickle-like path back and forth in an opposite sense.

During operation of the apparatus, the carriage 3 moves slowly along the tub (double arrow in FIG. 1) back and forth while, at the same time, the nozzle heads 9 are moved by the rotation or pivot movement of the gears 10, 11 along a circular or sickle-like path synchronously in opposite directions. The water jets emitted from the nozzle heads 9 and directed onto the bottom side of the foil 2 move accordingly so as to provide for a corresponding massaging of the patient resting on the foil 2.

Obviously, instead of one, two or more nozzle heads may be provided on each gear, or respectively, crank and also more than two gears or cranks 10, 11 may be provided.

It is also possible to provide for the apparatus only a single motor which drives the carriage and also the cranks. Then a switch-over structure for changing the direction of rotation of the motor may be provided at the end positions of the carriage in the tub.

By way of a control device, the movement speed of the carriage, the speed of rotation or of pivoting of the gears or cranks 10, 11 and the water pressure, that is the massaging intensity by the water jets, may be adjustable. It would also be possible that the cranks or gears are not engaged with each other but each crank is provided with its own drive motor. Then the cranks can be operated selectively in the same sense or in the opposite sense.

As already mentioned also more than two cranks could be provided. With two as well as more cranks, rotation in the same sense can be provided by only one motor by corresponding drive connections between the cranks for example by way of a toothed belt or chain drive. It is also possible to use four nozzles in connection with four cranks which are driven in groups of two wherein not only opposite sense movements but also different speed are possible.

Obviously other variants may be provided because of the many design possibilities for the drive of the cranks as well as movement of the carriage, which do not need to be described.

1. An apparatus for dry water jet massaging, comprising a tub (1), a foil (2) covering said tub (1) so as to form a support surface, and a mechanism arranged in said tub (1) for generating water jets, which are directed from below onto said foil (2), said mechanism including a carriage (3) supported in said tub (1) so as to be movable back and forth longitudinally in said tub (1) and means for moving said carriage (3), said carriage (3) carrying water nozzles directed toward the foil (2) and a water pump (15) with hoses connected to said water nozzles by way of flexible hoses (14) for supplying water under pressure to said nozzles, each of said water nozzles being incorporated in a nozzle head (9) which is freely rotatably supported on a crank element (10, 11) supported on said carriage (3) and drive means operating said crank elements (10, 11) so as to rotate or pivot the crank elements (10, 11) on the carriage (3).

2. An apparatus according to claim 1, wherein said carriage (3) carries at least two crank elements (10, 11) each of which is provided with at least one nozzle head (9).

3. An apparatus according to claim 2, wherein said at least two crank elements (10, 11) are operatively connected by way of a drive to a common drive motor for concurrent rotation in the same or an opposite sense.

4. An apparatus according to claim 3, wherein the crank elements (10, 11) are gears which are in engagement with each other and of which only one (10) is driven by the drive motor.

5. An apparatus according to claim 2, wherein each crank (10, 11) is driven by a different drive motor.

6. An apparatus according to claim 1, wherein said carriage (3) is movable by means of a drive structure (8) extending along one side of said tub (1).

7. An apparatus according to claim 6, wherein a toothed belt extends along a longitudinal wall of the tub (1) and a pinion (7) supported on said carriage (3) is in engagement with said toothed belt and operatively connected to a drive motor (6) disposed on said carriage (3) for moving said carriage (3).

8. An apparatus according to claim 1, wherein said water pump is mounted onto said carriage (3).

9. An apparatus according to claim 1, wherein said crank elements (10, 11) are continuously rotating in one direction.

10. An apparatus according to claim 1, wherein said crank elements (10, 11) are pivoting back and forth between opposite end positions.

11. An apparatus according to claim 1, wherein the speed of movement of the carriage (3) the pressure of the water jet the speed of movement of the crank elements (10, 11) and the temperature of the water for the water jets are independently controllable.

12. An apparatus according to claim 10, with several independently operated crank elements (10, 11), the rotational speeds of the individual crank elements are independently controllable.
